(19) United States
(12) Patent Application Publication
(10) Pub. No.: US 2003/0013502 A1
(43) Pub. Date: Jan. 16, 2003

(54) Hand-free handset for cellular telephone

(76) Inventor: Neng Wen Lin, Taipei (TW)

Correspondence Address: Keith Kline, PRO-TECHTOR INTERNATIONAL SERVICES, 20775 Narada Court, Saratoga, CA, 95070-3018, US

(21) Appl. No.: 09/905,135

(22) Filed: Jul. 12, 2001

(51) Int. Cl. H04M 1/00

(52) U.S. Cl. 455/569; 455/568

(57) ABSTRACT

A hand-free handset for cellular telephone includes a transparent housing, a control circuit board, a voice output device, a receiver, and a power control circuit, the power control circuit triggering an incoming signal display control unit of the control circuit board to flash a set of light emitting elements when the power control circuit detected input/output audio frequency signal of the cellular telephone.

### BACKGROUND OF THE INVENTION

The present invention relates to a hand-free handset for cellular telephone and, more particularly to such a hand-free handset, which drives a set of light emitting elements to flash when the cellular telephone is being called.

Following fast development of high technology, a variety of versatile cellular telephones have been disclosed and have appeared on the market. Using a cellular telephone has become a requisite activity in our daily life. However, when the cellular telephone rings in a noise place for example, a dancing hall, PUB, or ironworks, the user may be unable to hear the ringing sound of the cellular telephone. In this case, an important call may be missed. There are known incoming signal display devices adapted for use with a cellular telephone. These incoming signal display devices give a visual signal when the cellular telephone receives a signal. These incoming signal display devices are functional, however they do not provide any additional function.

### SUMMARY OF THE INVENTION

The present invention has been accomplished under the circumstances in view. It is one object of the present invention to provide a hand-free handset for cellular telephone, which enables the user to use the cellular telephone without holding it in hand and, which flashes when the cellular telephone receives a calling signal. It is another object of the present invention to provide a hand-free handset for cellular telephone, which can be controlled to change the flashing pattern. According to one aspect of the present invention, the hand-free handset for cellular telephone comprises a transparent housing, a control circuit board, a voice output device for output of voice signal from the cellular telephone, a receiver for transmitting voice signal from the user to the cellular telephone, and a power control circuit, the power control circuit triggering an incoming signal display control unit of the control circuit board to flash a set of light emitting elements when the power control circuit detected input/output audio frequency signal of the cellular telephone. According to another aspect of the present invention, the incoming signal display control unit can be controlled to flash the light emitting elements according to one of a set of predetermined flashing patterns.

### BRIEF DESCRIPTION OF THE DRWINGS

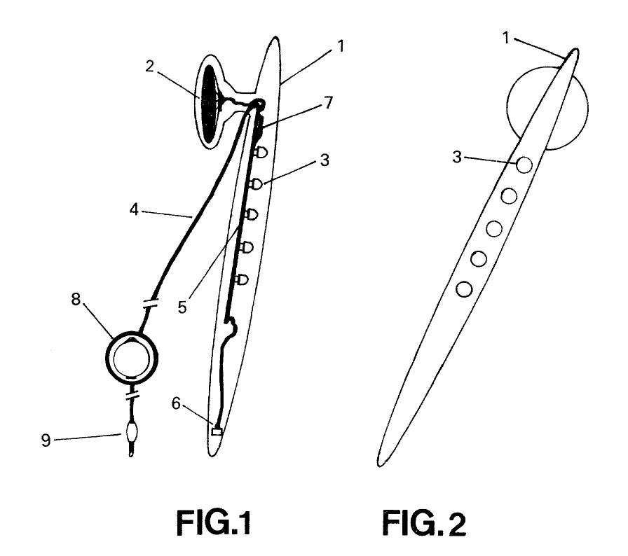

FIG. 1 illustrates a hand-free handset for cellular telephone constructed according to the present invention.

FIG. 2 is a side view of the hand-free handset for cellular telephone according to the present invention.

### DETAILED DESCRIPTION OF THE PREFERRED EMBODIMENT

Referring to FIGS. 1 and 2, a hand-free handset for cellular telephone in accordance with the present invention is shown comprised of a housing 1, a control circuit board 2, a voice output device 3, a receiver 4, and a power control circuit 5. The hand-free handset is connected to a cellular telephone for enabling the user to use the cellular telephone without holding the cellular telephone with the hand. The hand-free handset flashes when the cellular telephone receives a call signal.

The housing 1 is preferably molded from transparent or semi-transparent plastics, comprising a plug 11 for insertion into the user's ear, and a rod member 12 extended from the plug 1. The rod member 12 is so constructed that the free end of the rod member 12 is suspending nearby the user mouth after insertion of the plug 1 into the user's ear. The control circuit board 2 comprises an incoming signal display control unit 21, and a set of light emitting elements, for example, LEDs (light emitting diodes) 22. Upon receipt of signal from the power control circuit 5, the incoming signal display control unit 21 drives the LEDs 22 to flash. The voice output device 3 can be a speaker installed in the plug 11 and electrically connected to the control circuit board 2. The receiver 4 can be a microphone installed in the rod member 12 at a suitable location. The power control circuit 5 has a battery set mounted on the inside, an electric wire 51 extended from one end thereof and connected to the control circuit board 2 to provide the control circuit board 2 with the necessary working voltage and to transmit voice frequency signal from the cellular telephone to the voice output device 3 through the control circuit board 2, and an electric connector 52 extended from an opposite end thereof for connection to the cellular telephone.

When in use, audio signal from the cellular telephone is transmitted through the electric connector 52 to the power control circuit 5, and then transmitted to the voice output device 3 through the control circuit board 2 via the an electric wire 51, and the user's speech is received by the receiver 4 and transmitted by the receiver 4 to the control circuit board 2 and then transmitted to the cellular telephone by the control circuit board 2 through the electric wire 51 and electric connector 52 of the power control circuit 5 and then transmitted by the cellular telephone into the air by radio. During audio signal input output operation of the hand-free handset, the incoming signal display control unit 21 drives the LEDs 22 to flash. The incoming signal display control unit 21 can also be directly controlled by radio wave from the cellular telephone to drive the LEDs 22 to flash according to any of a variety of predetermined flashing pattern.

A prototype of hand-free handset for cellular telephone has been constructed with the features of FIGS. 1 and 2. The hand-free handset for cellular telephone functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A hand-free handset for cellular telephone comprising:
a housing, said housing comprising a plug for insertion into the user's ear, and a rod member extended from one end of said plug toward the user's mouth;
a control circuit board mounted inside said housing, said control circuit board comprising a set of light emitting elements, and an incoming signal display control unit adapted to drive said light emitting elements to flash;
a voice output device mounted inside said plug and connected to said control circuit board for voice signal output;
a receiver installed in said rod member of said housing and adapted to pick up the user's speech; and
a power control circuit adapted to connect said control circuit board to a cellular telephone and to detect audio frequency signal from the cellular telephone;
wherein when said power control circuit detects the presence of audio frequency signal from the cellular telephone, said control circuit board drives said incoming signal display control unit to flash said light emitting elements.

2. The hand-free handset for cellular telephone of claim 1 wherein said housing is injection-molded from transparent plastics.

3. The hand-free handset for cellular telephone of claim 1 wherein said housing is injection-molded from semi-transparent plastics.

4. The hand-free handset for cellular telephone of claim 1 wherein said light emitting elements are light emitting diodes.

5. The hand-free handset for cellular telephone of claim 1 wherein said voice output device is a speaker.

6. The hand-free handset for cellular telephone of claim 1 wherein said receiver is a microphone.

7. The hand-free handset for cellular telephone of claim 1 wherein said power control circuit comprises an electric wire extended from one end thereof and connected to said control circuit board.

8. The hand-free handset for cellular telephone of claim 7 wherein said power control circuit further comprises an electric connector extended from an opposite end thereof for connection to the cellular telephone for transmitting signal between the cellular telephone and said control circuit board.

9. The hand-free handset for cellular telephone of claim 1 wherein said power control circuit comprises a battery set adapted to provide electricity to said control circuit board.

10. The hand-free handset for cellular telephone of claim 1 wherein said incoming signal display control unit receives radio wave from the cellular telephone, and drives said light emitting elements to flash upon receipt of radio wave from the cellular telephone.

11. The hand-free handset for cellular telephone of claim 1 wherein said incoming signal display control unit drives said light emitting elements to flash according to one of a set of predetermined flashing patterns.
